(19) United States
(12) Patent Application Publication
(10) Pub. No.: US 2005/0131918 A1
(43) Pub. Date: Jun. 16, 2005

(54) Personalized profile for evaluating content

(76) Inventors: W. Daniel Hillis, Encino, CA (US); Bran Ferren, Beverly Hills, CA (US)

Correspondence Address: GLENN PATENT GROUP, 3475 EDISON WAY, SUITE L, MENLO PARK, CA, 94025, US

(21) Appl. No.: 10/852,804

(22) Filed: May 24, 2004

Related U.S. Application Data
(60) Provisional application No. 60/529,245, filed on Dec. 12, 2003.

(51) Int. Cl. G06F 17/30

(52) U.S. Cl. 707/100

(57) ABSTRACT

The invention provides a method and apparatus for evaluating content by combining ratings obtained from one or more evaluation systems according to the preferences of a particular user. To determine a combined rating for a portion of content of interest to the user, an evaluation profile, potentially unique to the user, is consulted to identify at least one contributing evaluation system. Each of the contributing evaluation systems identified is queried to obtain a rating that represents the value of the content, as judged by an evaluation authority that manages the evaluation system. The ratings obtained are combined in a manner specified by the evaluation profile to determine a combined rating that is presented to the user. The combined rating therefore provides a personalized indication of the value of the content to the user.

### RELATED APPLICATIONS

This application claims priority to U.S. patent application Ser. No. 10/854,622, entitled Delegated Authority Evaluation System, filed May 25, 2004; U.S. patent application Ser. No. 10/474,155 entitled Knowledge Web, filed Oct. 1, 2003; and to U.S. patent application Ser. No. 60/529,245 entitled Reputation System, filed Dec. 12, 2003; each of which are incorporated herein, in its entirety by this reference thereto.

### BACKGROUND

1. Technical Field

The invention relates to systems for assessing the value of informational content. More particularly, the invention relates to systems for evaluating the content in a manner personalized to a particular user.

2. Description of the Prior Art

Many sites found on the World Wide Web allow users to evaluate content found within the site. For example, the Amazon® web site (www.amazon.com) allows users to submit reviews of books listed for sale, including a zero to five star rating. The Slashdot web site (www.slashdot.org) allows users to “mod” comments recently posted by other users. Based on this information, the system determines a numerical score for each comment ranging from 1 to 5.

However, such approaches to evaluating content are limited in their ability to indicate the trustworthiness of the reviews and comments. For example, Amazon® merely allows other users to evaluate the submitted reviews by indicating that they found a review helpful. Slashdot allows users to annotate submitted comments with attributes such as “funny” or “informative.” The large number of submitted comments can then be filtered based on these annotations and the numerical score described above.

Furthermore, each of these approaches essentially relies on a mass consensus in which each evaluation authority, i.e. each contributor, is granted equal significance. Moreover, the manner in which the reviews and scores are calculated is not dependent on the type, i.e. form or topic, of the content itself. Finally, the manner in which the reviews and scores are calculated cannot be customized to suit the preferences of a particular user.

What is needed is a method of evaluating content that combines ratings obtained from multiple evaluation authorities to yield a more meaningful combined rating for a particular portion of content. In particular, it would be desirable to allow users to combine the evaluation systems in a flexible manner that is varied based on the type of content under consideration and the preferences of a particular user.

### SUMMARY

The invention provides a method of evaluating content by combining ratings obtained from one or more evaluation systems according to the preferences of a particular user. To determine a combined rating for a portion of content of interest to the user, an evaluation profile, potentially unique to the user, is consulted to identify at least one contributing evaluation system. Each of the contributing evaluation systems identified is queried to obtain a rating that represents the value of the content, as judged by an evaluation authority that manages the evaluation system. The ratings obtained are combined in a manner specified by the evaluation profile to determine a combined rating that is presented to the user. The combined rating therefore provides a personalized indication of the value of the content to the user.

In the preferred embodiment of the invention, the rating obtained from each evaluation system is a numeric value. The evaluation profile may specify any one of a number of methodologies for determining the combined rating, including averaging and weighted averaging, that may include the calculation of sums, means, modes, and medians. Greater variation in the methodologies used to determine combined ratings may be obtained by defining new evaluation profiles as combinations of existing profiles.

The ratings may indicate any one or more of various notions, including the reliability, trustworthiness, accuracy, impartiality, and quality of the content. Furthermore, the ratings may be applied to various types of content, including content of various forms and topics. In the preferred embodiment of the invention, the particular evaluation profile used to determine the combined rating depends on content type, which is determined by consulting an annotated database. Alternatively, and particularly in the case of content stored within the World Wide Web, a standard profile may be used for content for which a type cannot be determined.

In a community of users accessing a common body of content, the users may share a common set of evaluation systems. Individualized evaluation profiles, however, allow the users to evaluate content in a personalized manner. In such a community, the evaluation systems may precompute and cache the ratings for the portions of content for which ratings are most frequently requested. If evaluation profiles are stored in a location accessible to other users, the other users may define new evaluation profiles in terms of the existing, publicly accessible evaluation profiles. Finally, by analyzing the definitions of the publicly accessible evaluation profiles, a consensus among the community of users can be determined.

### BRIEF DESCRIPTION OF THE DRAWINGS

FIG. 1 shows a schematic representation of a rating system in which a server queries a plurality of evaluation systems according to a preferred embodiment of the invention;

FIG. 2 shows a schematic representation of a rating system in which a client queries a plurality of evaluation systems according to an alternative embodiment of the invention;

FIG. 3 shows a flow chart for determining a combined rating for un-typed content according to the invention; and

FIG. 4 shows a flow chart for determining a combined rating for potentially typed content according to a preferred embodiment of the invention.

### DESCRIPTION

The invention provides a method of evaluating content by combining ratings obtained from one or more evaluation systems according to the preferences of a particular user. To determine a combined rating for a portion of content of interest to the user, an evaluation profile, potentially unique to the user, is consulted to identify at least one contributing evaluation system. Each of the contributing evaluation systems identified is queried to obtain a rating that represents the value of the content, as judged by an evaluation authority that manages the evaluation system. The ratings obtained are combined in a manner specified by the evaluation profile to determine a combined rating that is presented to the user. The combined rating therefore provides a personalized indication of the value of the content to the user.

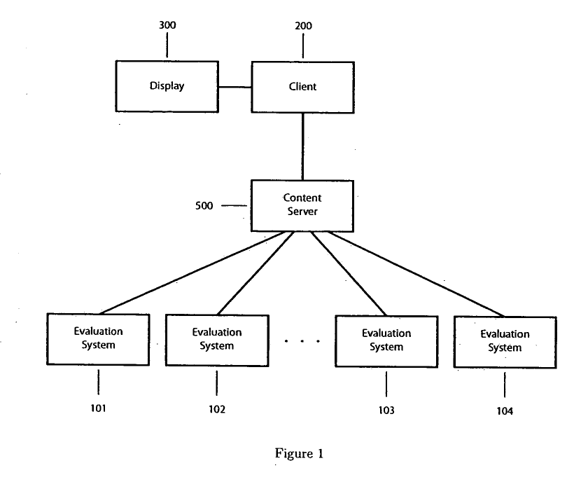

FIG. 1 shows a schematic representation of a rating system in which a server queries a plurality of evaluation systems according to a preferred embodiment of the invention. A client 200 is communicatively coupled to a content server 500 to which it submits requests for content and from which it receives content. The client is also communicatively coupled to a display 300, through which it presents the received content to the user. The content server is also communicatively coupled with a number of evaluation systems 101, 102, 103, and 104. The evaluation systems are queried by the content server to obtain the ratings used in determining the combined rating.

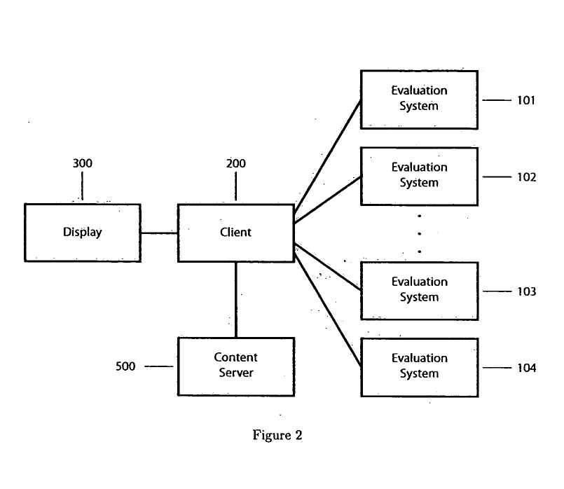

FIG. 2 shows a schematic representation of a rating system in which a client queries a plurality of evaluation systems, according to an alternative embodiment of the invention. As in FIG. 1, a client 200 is communicatively coupled to a content server 500 to which it submits requests for content and from which it receives content. The client is also communicatively coupled to a display 300, through which it presents the received content to the user. In contrast to FIG. 1, however, the client is communicatively coupled with a number of evaluation systems 101, 102, 103, and 104. Thus, while in the preferred embodiment of FIG. 1 the content server is responsible for querying the evaluation systems, this function may also be performed by the client, as in FIG. 2.

It is important to note that FIGS. 1 and 2 are schematic in nature. One or more of the elements shown in the figures may physically reside at a common location. Similarly, the computation associated with one or more of the elements may be executed on a single computer processor. Alternatively, the elements may reside in separate physical locations and be executed on separate processors.

The invention may be practiced in conjunction with the World Wide Web, in which any number of Web servers may comprise the content server of FIGS. 1 and 2. The evaluation systems 101, 102, 103, and 104 of FIGS. 1 and 2 may reside on the same Web server or a different Web server. Alternatively, or in addition, the invention may be practiced in conjunction with a very large, distributed, annotated database, such as the registry described in U.S. patent application Ser. No. 10/474,155, filed Oct. 21, 2003, entitled Knowledge Web.

Generally, the ratings obtained from the evaluation systems indicate the value of the content, as judged by an evaluation authority that manages the evaluation system. An evaluation authority may be commercial, such as the American Medical Association, or may be private, such as a peer of the user or the user himself.

Preferably, the ratings obtained from each evaluation system are numeric. For example, an evaluation system may return a numeric rating between −1 and 1, or between 0 and 1. The evaluation may be performed manually by human reviewers or may be computed in an automated manner. A detailed example an evaluation system suitable for use with the invention is detailed in U.S. patent application Ser. No. 60/529,245 entitled Reputation System, filed Dec. 12, 2003.

The ratings, and therefore the resulting combined ratings, may apply to content of various types. For example, the rating may apply to content of different forms, e.g. actual content such as scientific articles, tutorials, news stories, or editorials; or content referencing external items, such as products for sale or movies currently playing in theaters. The ratings may also be applied to content of various topics, such as science, biology, entertainment, and skiing.

Furthermore, there are several senses in which actual content and referenced items can be evaluated. For example, a numerical credibility may be assigned, reflecting notions such as trustworthiness, reliability, accuracy, and impartiality. Alternatively, a numerical quality may be assigned, indicating an overall degree of excellence. The particular notions encompassed by the ratings are not essential to the underlying methodology of the invention. It is thus anticipated that the invention may be practiced to provide ratings encompassing these and other notions.

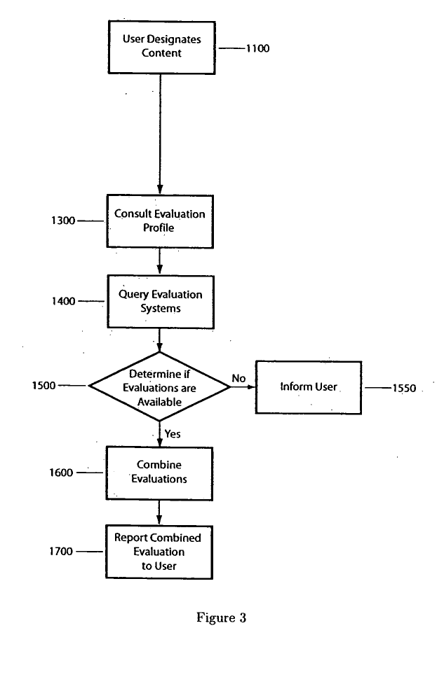

FIG. 3 shows a flow chart for determining a combined rating for un-typed content according to the invention. The rating procedure begins when a user designates content 1100 of interest for which he wishes to determine a rating. The designation is preferably accomplished using the display 300 and client 200 of FIGS. 1 and 2. The user may designate the content of interest within content already received by the client from the server by clicking or otherwise highlighting it with a mouse or equivalent pointing device, and then prompting the client to determine a rating, for example via a pull-down menu, a contextual menu, or a keyboard shortcut. Alternatively, for certain types of content, it may be inferred from the request for the content that the user wishes to determine a rating. This approach may be particular effective in the embodiment of FIG. 1, where the content server 500 is tasked with determining the rating.

Once the content to be evaluated has been designated by the user, the system consults an evaluation profile 1300. As the content is un-typed in this embodiment of the invention the profile consulted is common to all content. However, it may be unique to the particular user requesting evaluation of the content. Accordingly, the evaluation profile is preferably maintained by and stored within the client 200 of FIGS. 1 and 2, though it may alternatively be maintained by and stored within the content server 500. The evaluation profile indicates which evaluation systems should be queried and how the ratings returned by the evaluation systems should be combined to determine the combined rating.

After the evaluation profile is consulted, the system queries the evaluation systems 1400 specified by the evaluation profile. Each of the evaluation systems that have evaluated the content of interest returns a rating, preferably numeric. In the preferred embodiment of FIG. 1, the content server queries the evaluation systems, while in the configuration of FIG. 2, the server provides an indication to the client that evaluations are available, and the client then queries the evaluation systems directly.

It is possible that not all of the evaluation systems return a rating, so the system then determines if the available ratings are sufficient 1500 for determining the combined rating. This determination depends on the specific methodology by which the ratings are combined, as discussed below. The determination is preferably performed by the same device, i.e. client or server, that maintains and stores the evaluation profile. If the available ratings are not sufficient, the system informs the user 1550 via the client 200 that a reliable combined rating could not be determined.

If the available ratings are sufficient, the ratings are combined 1600 as specified by the evaluation profile. The combination is preferably performed by the same device, i.e. client or server, that maintains and stores the evaluation profile. The ratings may be combined by any number of methods. In the case of numerical values, the ratings may be combined by an averaging scheme, preferably a weighted averaging scheme, in which the weights reflect the relative degree to which the user values the opinion of the evaluation authority that manages each evaluation system. Medians and modes may be computed to discern a consensus among the evaluation systems.

It is also possible to compute a combined rating that reflects the pervasiveness of a portion of content. Most simply, the number of evaluation systems that return a rating for the content may be counted, providing a direct indication of how widely the content has been disseminated. Alternatively, the ratings associated with the content may be added. In this approach, portions of content that have been rated by many evaluation systems generally have a higher combined rating than those that have been evaluated by only a few evaluation systems. This approach to computing the combined rating may also be used to incorporate the age of the content into the combined rating, as a portion of content will presumably be evaluated by an increasing number of evaluation systems over time.

As noted above, the sufficiency of the available ratings in determining the combined rating depends on the combination methodology. In the case of combinations involving averaging, a combined rating can be determined even in the absence of one or more ratings. In principle, the combined rating could be determined with only a single available rating. However a user may wish to specify that a minimum fraction, or quorum, of evaluation systems return a rating if a combined rating is to be computed.

Finally, the system reports the combined rating to the user 1700 via the display 300. Optionally, the system may report the individual ratings received from each of the evaluation systems that were queried to determine the combined rating. The identity of the evaluation authority managing the queried evaluation systems may also be provided to the user.

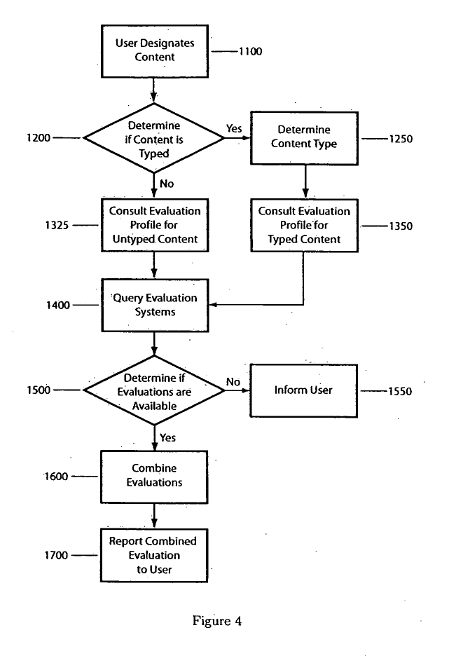

FIG. 4 shows a flow chart for determining a combined rating for potentially typed content according to a preferred embodiment of the invention. The procedure outlined is similar to that of FIG. 3, with several additional steps to use the potentially typed nature of the content.

Once the content to be evaluated has been designated by the user 1100, a check is performed to determine if the content is typed 1200. Preferably, this is accomplished by searching for the content within a very large, distributed, annotated database such as the registry described in U.S. patent application Ser. No. 10/474,155, filed Oct. 21, 2003, entitled Knowledge Web. However, type may also be determined using markup tags within the content itself, such as those of XML (www.xml.org).

If the content is found to be un-typed, the system consults a standard evaluation profile for untyped content 1325. The standard evaluation profile is preferably similar to that consulted 1300 in FIG. 3. The remainder of the procedure is as shown in FIG. 3.

If, however, the content is found to be typed, the system then determines the specific content type 1250. The system selects and consults an evaluation profile for typed content 1350. The particular evaluation profile selected and consulted is based upon the type of the content and the preferences of the user. If the user has not specified an evaluation profile for the determined type of content, a default evaluation profile for the type of content may be consulted. The remainder of the procedures is then as described in FIG. 3.

Thus, the particular methodology used to determine the combined rating depends upon the type of content and the preferences of the user. As noted above, the type may indicate information such as the form and topic of the content. By specifying which evaluation profile should be used for which type of content, the user may thereby indicate the combination methodology that should be applied to particular forms and topics of content.

For example, a user may select a first set of three evaluation systems for evaluating opinion-editorials in the area of foreign policy. He may further specify that the three evaluation systems be combined by a weighted average in which the first evaluation system is given a weight equal to the combined weight of the second and third evaluation systems. A different evaluation profile may be used for entertainment reviews, or for technical medical literature.

The user may also specify that the sense in which content is evaluated may also depend upon the type of content. For example, ratings reflecting credibility may be applied to actual content, such as articles, whereas ratings reflecting quality may be applied to content referencing external items, such as products available for purchase. In the latter case, ratings reflecting quality may themselves be evaluated with regard to credibility, because numerical ratings reflecting quality are themselves actual content.

The basic concepts of the invention may be extended in a variety of ways. For example, a user may specify evaluation profiles as combinations of existing evaluation profiles. For example, an evaluation profile for literature and an evaluation profile for medicine may be combined to yield a profile suitable for evaluating medical literature.

In another extension of the invention, the combined rating is used to filter content displayed by the client 200. In this embodiment, content for which a combined rating cannot be determined and content for which a rating can be determined, but where the rating does not meet a threshold set by the user, is not displayed by the client. This functionality can be applied to filter search results, where each portion of content returned by the search engine is evaluated prior to display to the user.

Several important aspects of the invention are apparent when considering a community of users, each of whom maintains individualized evaluation profiles for a common body of content. While such a community of users may, in the interest of efficiency, share a common set of evaluation systems maintained by a common set of evaluation authorities, the individualized evaluation profiles allow the users to evaluate content in a truly personalized manner.

To improve the efficiency of the evaluation process further, evaluation systems may keep a record of those portions of content for which ratings are most frequently requested. The evaluation systems may then precompute and cache the ratings for these portions of content, thereby increasing the speed with which they can respond to requests for ratings.

If one or more of the users stores his evaluation profiles in a location accessible to other users, the other users may define new evaluation profiles in terms of the existing, publicly accessible evaluation profiles. Most simply, a user may copy the definition of an evaluation profile from another user. Alternatively, an evaluation profile may be defined as a combination of two or more evaluation profiles defined by one or more other users. Such functionality is particularly useful for new users, who may wish to get up and running quickly by borrowing evaluation profiles from other users they trust and respect.

Finally, by analyzing the definitions of the publicly accessible evaluation profiles, a consensus among the community of users can be determined. For example, for a particular type of content, or for all content generally, the most commonly referenced and the most heavily weighted evaluation systems can be determined. This information may be used to define the standard and default evaluation profiles described previously.

The nature of the invention may be more clearly illustrated by considering the following example, following the procedure outline in FIG. 4.

A user recently diagnosed with high cholesterol has located a newspaper article entitled “Effects of Exercise on HDL Cholesterol,” and would like an evaluation of the credibility of the article. The user designates the article in and requests and evaluation via a client designed for browsing content. The client then determines if the content is typed. Annotations indicate that the content is a technical article in the field of medicine. Among the several personalized evaluation profiles maintained by the user is a profile intended to evaluate technical articles in the medical fields. Accordingly, this profile is consulted to determine which evaluation systems should be queried.

The profile indicates that evaluation systems administered by the American Medical Association, the Centers for Disease Control, the National Institutes of Health, and Nature magazine should be queried. In response to the query for a content rating, the evaluation system managed by the American Medical Association returns a value of −0.03, the evaluation system managed by the National Institutes of Health returns a value of −0.23, and the evaluation system managed by Nature magazine returns a value of 0.15. The evaluation system managed by the Centers for Disease control has not evaluated the article, and therefore does not return a rating.

The ratings returned by the evaluation systems are then combined to obtain a combined content rating. The consulted evaluation profile further indicates the relative weighting that should be applied to the ratings returned by the evaluation systems in performing this calculation. Specifically, the evaluation profile indicates that the evaluation system managed by the American Medical Association has a weighting of 15, the evaluation system managed by the Centers for Disease Controls has a weighting of 7, the evaluation system managed by the National Institutes of Health has a weighting of 25, and the evaluation system managed by Nature magazine has a weighting of 12. However, because the evaluation system managed by the Centers for Disease Control did not return a content rating, it is ignored in the calculation of the combined content rating. Using the preferred weighted average approach, the combined content rating is calculated as
R=[15(−0.03)+25(−0.23)+12(0.15)]/[15+25+12]=−0.08 (1)

Finally, the combined content rating of R=−0.08 is reported to the user, providing an evaluation of the credibility of the article of interest, specifically that the article should be considered slightly un-credible.

Although the invention is described herein with reference to several embodiments, including the preferred embodiment, one skilled in the art will readily appreciate that other applications may be substituted for those set forth herein without departing from the spirit and scope of the invention.

Accordingly, the invention should only be limited by the following claims.

1. A method for evaluating content, comprising the steps of:
consulting an evaluation profile which represents evaluation preferences of a user to identify at least one contributing evaluation system;
obtaining at least one content rating from said at least one contributing evaluation system;
determining, based upon said at least one content rating, as specified by said evaluation profile, a combined content rating; and
reporting said combined content rating to a user;
wherein said combined rating provides a personalized indication of the value of said content to said user.

2. The method of claim 1, wherein each of said at least one contributing evaluation systems is managed by an evaluation authority, and
wherein said evaluation profile indicates said user's confidence in said evaluation authority.

3. The method of claim 1, additionally comprising the steps of, before said consulting step:
determining a type for said content; and
selecting said evaluation profile from among a plurality of available evaluation profiles based on said type.

4. The method of claim 3, wherein said type indicates any of:
a form of said content; and
a topic of said content.

5. The method of claim 3, wherein said type is specified within an annotated database; and wherein said type is determined by consulting said annotated database.

6. The method of claim 1, wherein said content is accessible via the World Wide Web.

7. The method of claim 1, wherein said evaluation profile is customized by said user.

8. The method of claim 1, wherein said evaluation profile comprises a combination of a plurality of evaluation profiles.

9. The method of claim 1, wherein said evaluation profile comprises at least one evaluation profile defined by an individual other than said user.

10. The method of claim 1, wherein, with regard to said content, said at least one content rating indicates any of:
reliability;
trustworthiness;
accuracy;
impartiality; and
quality.

11. The method of claim 1, wherein at least one of said at least one contributing evaluation system precomputes a content rating for portions of said content for which content ratings are frequently requested.

12. The method of claim 1, wherein a plurality of said evaluation profiles, each maintained by one of a plurality of users, are analyzed to determine a consensus among said plurality of users.

13. The method of claim 1, wherein said at least one content rating is numerical.

14. The method of claim 13, wherein said combining step comprises an averaging procedure.

15. The method of claim 14, wherein said averaging procedure comprises a weighted averaging procedure.

16. The method of claim 13, wherein said combining step comprises a calculation of any of:
a sum of said content ratings;
a mean of said content ratings;
a mode of said content ratings; and
a median of said content ratings.

17. A system for evaluating content comprising:
a plurality of evaluation profiles, each maintained by at least one of a plurality of users;
a plurality of evaluation systems;
means for identifying a portion of content of interest to a user;
means for consulting at least one evaluation profile maintained by said user, said consulting means identifying, among said evaluation systems, at least one contributing evaluation system;
means for obtaining at least one content rating for said portion of content from said at least one contributing evaluation system;
means for determining, based on said at least one content rating, as specified by said at least one evaluation profile, a combined content rating; and
means for reporting said combined content rating to said user; and
wherein said combined content rating provides a personalized indication of the value of said content to said user.

18. The system of claim 17, wherein at least one of said evaluation profiles maintained by a first of said users is based on at least one evaluation profile maintained by at least a second of said users.

19. The system of claim 17, wherein at least one of said at least one contributing evaluation system precomputes a content rating for portions of said content for which content ratings are frequently requested.

20. The system of claim 17, wherein said evaluation profiles are analyzed to determine a consensus among said plurality of users.
